(19) United States
(12) Patent Application Publication
(10) Pub. No.: US 2013/0302541 A1
(43) Pub. Date: Nov. 14, 2013

(54) Special interchangeable accessory line device and the business method for its implementation as an enterprise

(71) Applicant: Kathlene Lynn Morgan, Anderson, IN (US)

(72) Inventor: Kathlene Lynn Morgan, Anderson, IN (US)

(21) Appl. No.: 13/468,204

(22) Filed: May 10, 2012

(51) Int. Cl. A44C 1/00; G06Q 10/00; A41G 1/00

(52) U.S. Cl. 428/24; 428/99; 705/1.1

(57) ABSTRACT

An interchangeable accessory device. It is a detachable fastener for securing, in a predetermined position, an object and an adornment such as a flower or bow. The objects may be headbands, clothing, purses, and the like. The interchangeable assembly has detachable, replaceable flowers or bows, etc. of various colors in order to accessorize outfits and objects to look vivid and beautiful. The device is comprised of a specially configured stud with positioning and other features to detachably interconnect with a socket component; the specially configured socket component with positioning and other features to detachably interconnect with the stud; a means to removably secure the stud to an adornment; and a means to removably secure the socket to an object wherein a person may detachably and position-ally connect the adornment to the object for full versatility and use of the interchangeable accessory line system.

### CROSS-REFERENCE TO RELATED APPLICATIONS

This application claims no benefit of earlier applications.

### FIELD OF INVENTION

This invention relates to a special interchangeable accessory line device and the business method for its implementation as an enterprise. The system and business method is collectively known as Snappz™. The interchangeability is a positioning fastener for fastening, in a predetermined position, an object and an adornment such as a flower or bow. The objects may be headbands, clothing, purses, totes, pet harnesses, gloves, formal wear or the like. The assembly is provided with movable and replaceable ornamental flowers or bows, etc. of various matching or contrasting colors so as to accessorize outfits and objects in order to look vivid and beautiful.

The present invention relates to fasteners for uniting object and adornment and more particularly to a fastener mechanism having first and second fastener components that interlock (in a predetermined position) to releasably unite the object and adornment. The present invention also relates to business systems and methods for implementation of the fastening system as an enterprise.

In summary, the present invention relates to means for decorating objects and clothing with fashionable adornments to become accessories. Specifically, the present invention relates to interchangeable, snap-on adornments for releasable attachment to a socket member fitted to the objects and clothing. More particularly the invention relates to a connecting device consisting of two members, one (socket) of which is permanently attached an object and the other (stud) which is attached to various adornments. The members are joined together. Other interchangeable adornments may be attached to the receiving object.

### FEDERALLY SPONSORED RESEARCH

None.

### SEQUENCE LISTING OR PROGRAM

None.

### BACKGROUND

### Field of Invention and Prior Art

As far as known, there are no special interchangeable accessory line devices or a business method for its implementation as an enterprise. It is believed that this product and method are unique in design and technologies.

### Problem Addressed

The accessory business in retail is a notably huge market. However, the economic recession has made all discretionary purchases much more difficult. Each purchase is scrutinized for price as well as versatility. Can the object purchased be used many times and certainly more than one time? The economies of reusing the accessories for different clothing outfits and for different occasions are attractive to a prudent spender, especially that spender that also wants fashionable accessories. Couple this economic necessity with a business method that coordinates and joins the accessory markets across personal/hobby; professional; wholesale and retail markets and one can see the huge economic leverage of coupling/coordinating this enterprise. The present interchangeable system does this. Other prior art falls short.

### PRIOR ART

Various kinds of fastener systems have attempted to answer the problem. One is a U.S. Pat. No. 6,374,420 issued in 2002 to Jossi is called “fastener and a two piece clothing comprising it”. It teaches a fastener for fastening a pair of clothing together, that comprises two complementary securing elements to be secured to a said pair of clothing. One fastening element has at least one fastening projection in a center region, while the other one has at least one opening for receiving the fastening projection. The center region is connected to at least one elongated securing surface which protrudes away from it. It is a textile strip to fasten to the paired objects like socks and things. It does not orient the held pairs and shows no use or ability for fastening adornments to objects. Another device was issued a U.S. Pat. No. 6,513,167 to Cheng in 2003. This was a fixed headband assembly that includes a main body of the headband, several sliding bases, several elastic stems, several ornamental blocks and a decorative strap. It includes sliding bases, has two hooks respectively formed on both sides and elastic stems with an ornamental block. The decorative strap is provided with decoration on the circumference. This is a rigid device, unusable for most objects anticipated with the Morgan device, and is not positional in fastening. It teaches no enterprise methods.

A U.S. Pat. No. 8,122,519 was issued in 2012 to Schmelzer et al. It shows a system and method for securing accessories to wearable items. The system and method for securing accessories to shoes and other wearable items is a system comprising a shaft having first and second ends; a first shoulder secured to the first end of the shaft, the first shoulder being configured for insertion through an expandable hole in the wearable item and configured to engage an inner surface of the wearable item; a second shoulder secured to the second end of the shaft, the second shoulder being configured to engage the wearable item; and a third shoulder adjacent to the second shoulder, the third shoulder comprising the decorative accessory. The device requires the shoes or clothing to have a receiving stretchable hole. It is more complex and appears more expensive than the Morgan device and method. It does not show positional control of the objects. An ornamental rivet apparatus especially for clothing or shoes is shown by U.S. Publication 2007/0084019 by Wilcox. What is taught is a decorative fastener for use upon an item to be worn by the user; the item to be worn may be a shoe, an item of clothing (including shirts, hats and caps, or the like), or even a pet collar. The fastener features two parts that may be connected together on opposite sides of the item to be worn, with the item situated between the bottom part and the top part. It has no positional features like the Morgan device.

An interchange snap-on device for adornments for fashion accessories was issued in 2000 as U.S. Pat. No. 6,012,203 to Pearson. It demonstrates an assembly that includes a socket member, a post element, a stud member, and a decorative element. The socket member is secured to a fashion article, such as clothing, accessories (e.g., belts, hats, purse, shoes, etc.) or undergarments using the post element. The decorative element is secured to a front side of the stud member to produce an adornment and may include, but is not limited to, rhinestones, acrylic stones, precious and semi-precious stones, beads, button heads, and crystals. An opposite side of the stud member is structured and configured for releasable, snap fit engagement within the socket member, wherein various individual ones of the assembled adornments may be attached, removed and interchanged on the fashion article in accordance with a desired color scheme, arrangement, and overall appearance. It fails to anticipate the positional device and system taught by Morgan. In U.S. Pat. No. 4,682,389 issued in 1987 to Callender taught a positional garment connector. It shows a multi-piece garment connector that is provided for interconnecting related garments or the like so as to prevent accidental separation of one from the other, as during laundering. The connector comprises male and female elements connectible temporarily to related garments such as a pair of hose, each element being provided with a simple attachment device, and the two elements are interconnected by fitting a tongue-like part on one element into a cavity in the other element. Cooperative parts of the elements provide a detent function operative normally to prevent withdrawal of the tongue from the cavity but yieldable to manual force to separate the cooperative detent portions as to enable such withdrawal. While this is a positional fastener, it does not anticipate the simple use with the vast accessory lines with various objects beyond garments.

Inventor Weber-Unger received a U.S. Pat. No. 6,163,938 issued in 2000 for a garment fastener. This taught a garment fastener that includes two constituent fastener components each of which is provided with a front disc and a back disc where a fabric section is sandwiched between these discs. In order to permit, to the greatest extent possible, one-handed manipulation and to cause the fastener components to center themselves automatically when in the closed state, one of the fastener components is provided at its perimeter with a hooked, U-shaped projection and the other, complementary fastener component is provided within its perimeter with a counter-hooked projection. In the closed state, the hook and counter-hook are partly engaged. Each fastener component contains a magnet which allows the fastener components to attract each other and to mutually center themselves. A strong pull in the closing direction causes a further, more positive engagement between the hook and counter hook. No business method is taught and the fastener is relatively more expensive than the Morgan concept. An apparatus and method for securely yet removably attaching ornaments to shoes, clothing, pet collars and the like was taught in a U.S. Pat. No. 8,069,538 issued to Wilcox in late 2011. It is a decorative charm and fastener system and its method for use upon an item to be worn by the user or a pet animal; the item to be worn may be a shoe, an item of clothing (including shirts, hats and caps, or the like), or a pet collar. The fundamental embodiment features a charm part and a base part that may be connected together on opposite sides of the item to be worn, with the item situated between the base part and the charm part. The system also includes an elastically compressible washer member that is placed upon the charm part. The compressible washer promotes a secure, yet temporary, connection between the charm part and base part when those respective parts are installed upon an item. Assortments of different charms thus are interchangeable for temporary attachment to the base part. The overall system is more complex design and number of parts than the Morgan invention. Likewise, the overarching business method offered by Morgan for expansive marketing across the full enterprise is lacking in the Wilcox art.

As can be seen from the previous art and as far as known, there are no special interchangeable accessory line device and the business method for its implementation as an enterprise or the like indicated in prior art. None of the known fastener devices or systems are suitable to effectively replace or be equivalent to the present exercise device by Morgan. It is believed that this product is unique in its design and technologies.

### SUMMARY OF THE INVENTION

This invention is a special interchangeable accessory line device and the business method for its implementation as an enterprise. Taught here are the ways for detachably connecting an adornment like flowers or bows to an object like clothing, headbands, barrette, totes, pet harnesses, purses, packages and the like.

The preferred embodiment is a special interchangeable accessory line system with a group of components, said components made of a durable material and comprised of (a) a specially configured stud with positioning and other features to detachably interconnect with a socket component; (b) the specially configured socket component with positioning and other features to detachably interconnect with the stud; (c) a means [such as a cap with a stem or pin] to removably secure the stud to an adornment; and (d) a means [such as a cap with a stem or pin] to removably secure the socket to an object [such as a headband, cloth, purse, barrette, tote, pet harness, nametag; or the like] wherein a person may detachably and position-ally connect the adornment to the object and later remove and replace the adornment and place the said adornment onto another object and replace the original adornment with an alternative adornment for full versatility and use of the interchangeable accessory line system. An alternative embodiment is a business method for increasing the versatility of the above described interchangeable accessory line system comprised of (a) a personal sub-method with steps and features; (b) a professional sub-method with steps and features; (c) an wholesale sub-method with steps and features; and (d) a retail sub-method with steps and features all interconnected by the interchangeable accessory line system for leveraging the financial gain of interchangeability across market channels.

### Objects and Advantages

There are several objects and advantages of the special interchangeable accessory line device and the business method for its implementation as an enterprise. The system and business method is collectively known as Snappz™.

The special interchangeable accessory line device and the business method for its implementation as an enterprise provide the following advantages:

Advantages of Snappz ™: In a word, it is Marketable.

| | |
|---|---|
| 1 | Practical |
| 2 | Specifications-every Snappz ™ is the same size |
| 3 | Freely replaces another |
| 4 | User-friendly |
| 5 | Everyday staple that still follows trends and Fads |
| 6 | Inter-mix: Mix old with new-Snappz ™ collection can |
| | be added to over the years. The new still fits the |
| | old products |
| 7 | Socioeconomic friendly |
| 8 | Cost Affective- i.e.-turn 1 headband into 500+ |
| | looks by changing the accessory |
| 9 | Extends useful life: Allows clothing to be worn |
| | more-i.e., Jean Jacket-change the look every day. |
| | Can be worn with jeans one day and then a dressy |
| | dress simply by changing the accessory-Parents of |
| | children will find they get more wear out of their |
| | child's wardrobe. |
| 10 | Enhances the total outfit: Enhancements that |
| | changes the appearance of an outfit in a snap-can |
| | go from day to night wear or casual to dressy |
| 11 | Timeless- for young and old people alike, babies to |
| | the octogenarians |
| 12 | Snappz ™ takes your wardrobe from ordinary to |
| | extraordinary-boots, hats, headbands, gloves, shoes |
| 13 | Organizer keeps Snappz ™ accessories organized and |
| | easy for children to mix and match for their everyday |
| | uses |
| 14 | Allows a child to take ownership of their appearance |
| 15 | Allows a child to enhance their individual look- |
| | show their personality-simple to gothic |
| 16 | Can be purchased separately |

Finally, other advantages and additional features of the present special interchangeable accessory line device and the business method for its implementation as an enterprise will be more apparent from the accompanying drawings and from the full description of the device. For one skilled in the art of fastening devices and business methods for complex marketing enterprises, it is readily understood that the features shown in the examples with this product and method are readily adapted to other types of fastening systems and devices and their related business methods to market and sell.

### DESCRIPTION OF THE DRAWINGS

### Figures

The accompanying drawings, which are incorporated in and constitute a part of this specification, illustrate a special interchangeable accessory line device and the business method for its implementation as an enterprise that are preferred. The drawings together with the summary description given above and a detailed description given below serve to explain the principles of the Special upper body exercise device for various applications. It is understood, however, that the Special Interchangeable Accessory Line is not limited to only the precise arrangements and instrumentalities shown. Nor is the Business Method for its Enterprise solely limited to the precise steps and methods shown here.

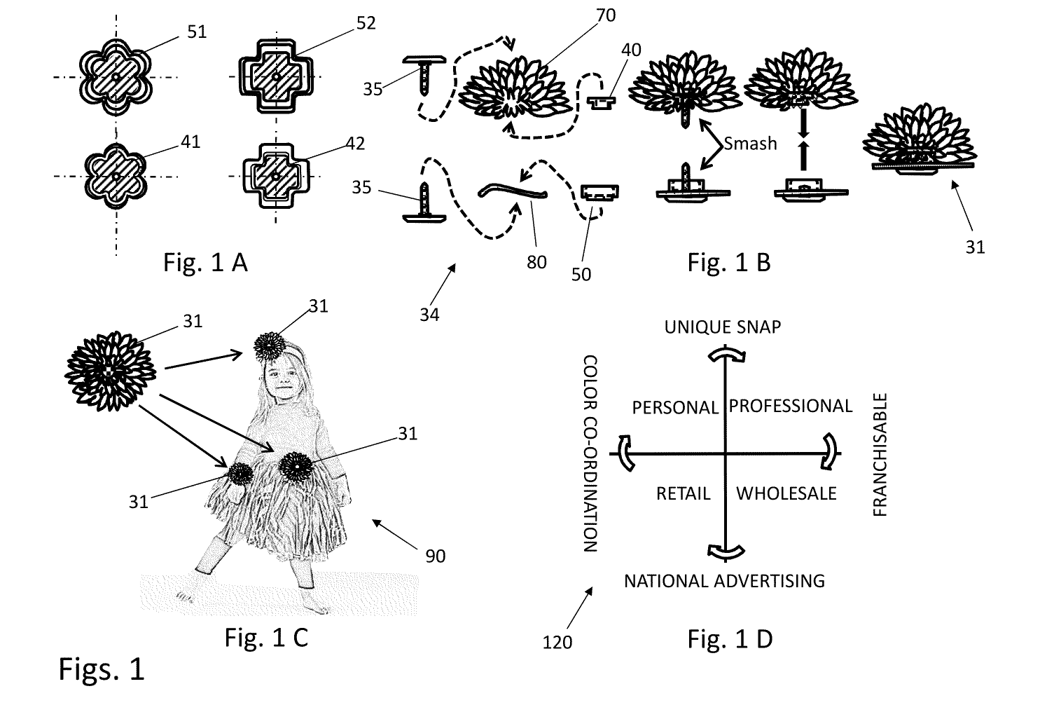

FIGS. 1 A through 1 D are examples of the snap device for interchangeability with the accessory line, a brief overview of assembling the snaps, a display of the line in use and the business method of leveraging the line financially with interconnected marketability.

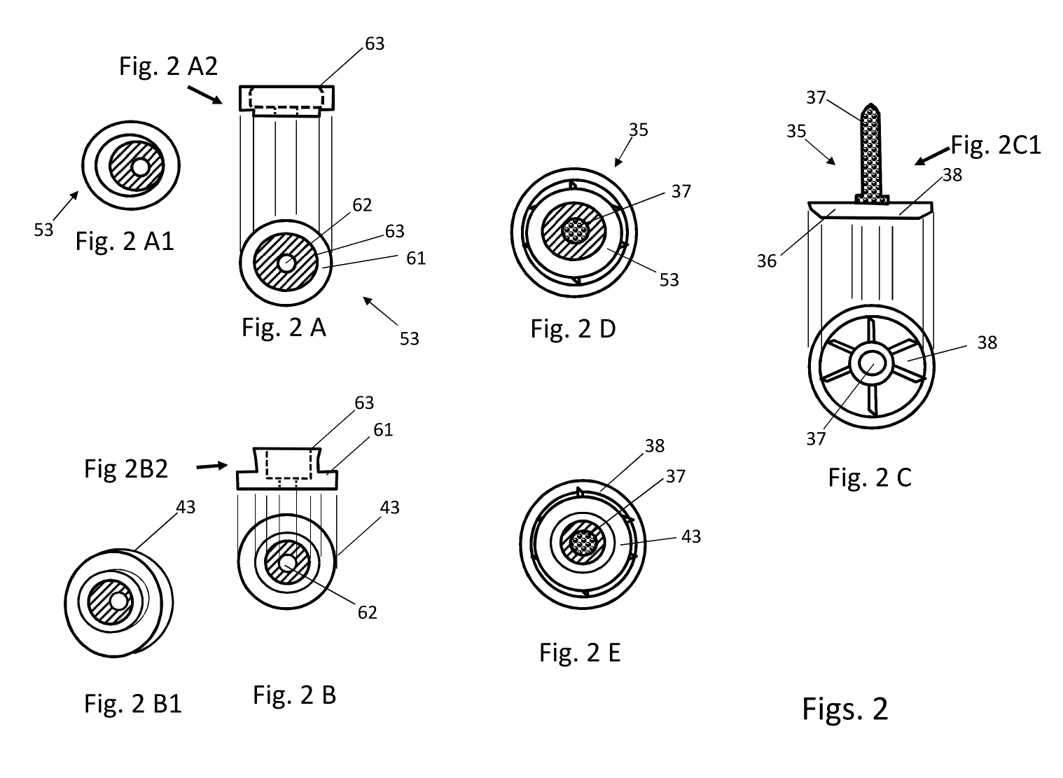

FIGS. 2 A through 2 E are sketches of the general snap consisting of a socket, stud and cap, the sketches shown from various views.

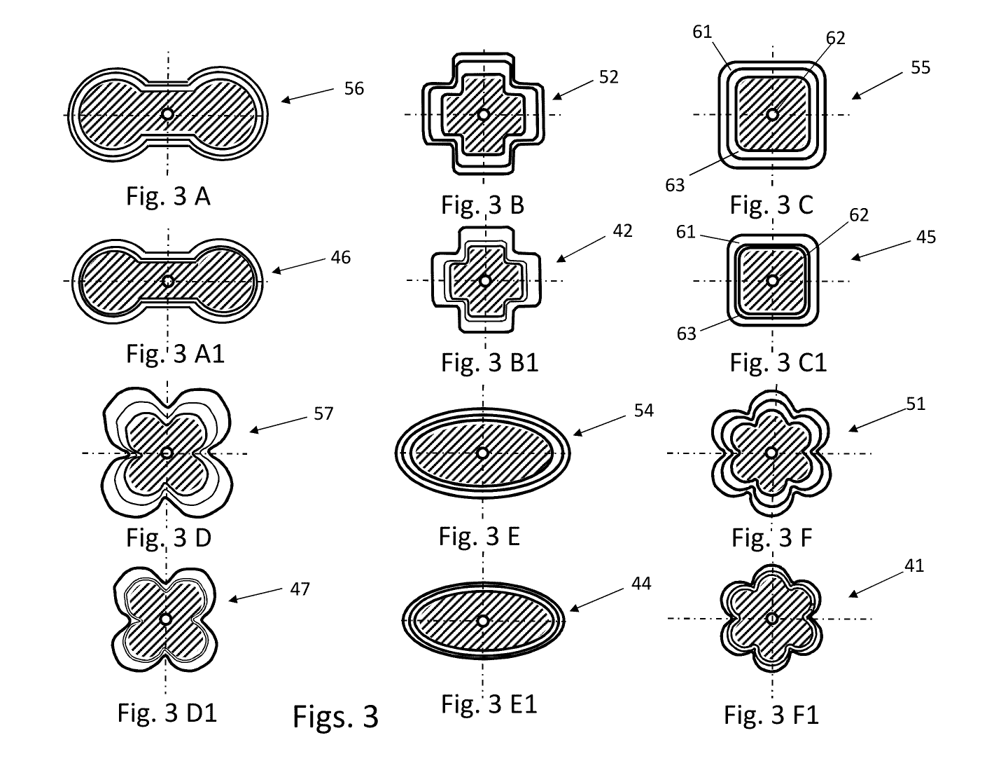

FIGS. 3 A through 3 F1 are examples of the various types of snap components anticipated with this accessory line—all shown from generally a top view.

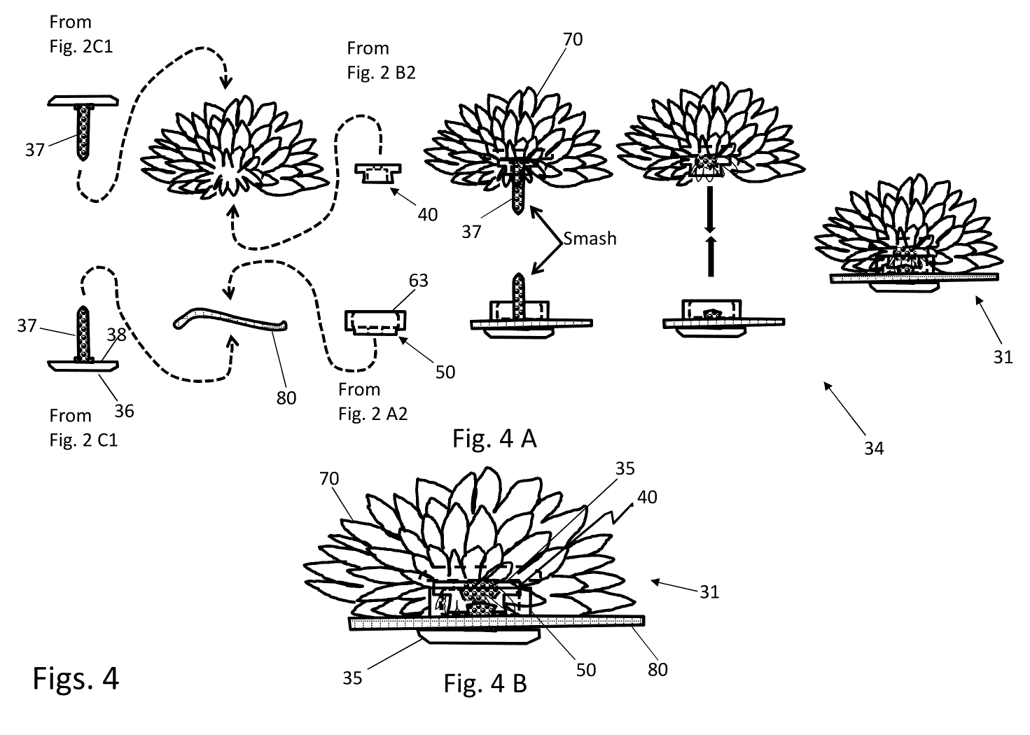

FIGS. 4 A and 4 B are sketches of the general assembly of the snap consisting of the cap, stud and sockets attached to the receiving object and the flower or other adornment. The components are shown from generally a side view.

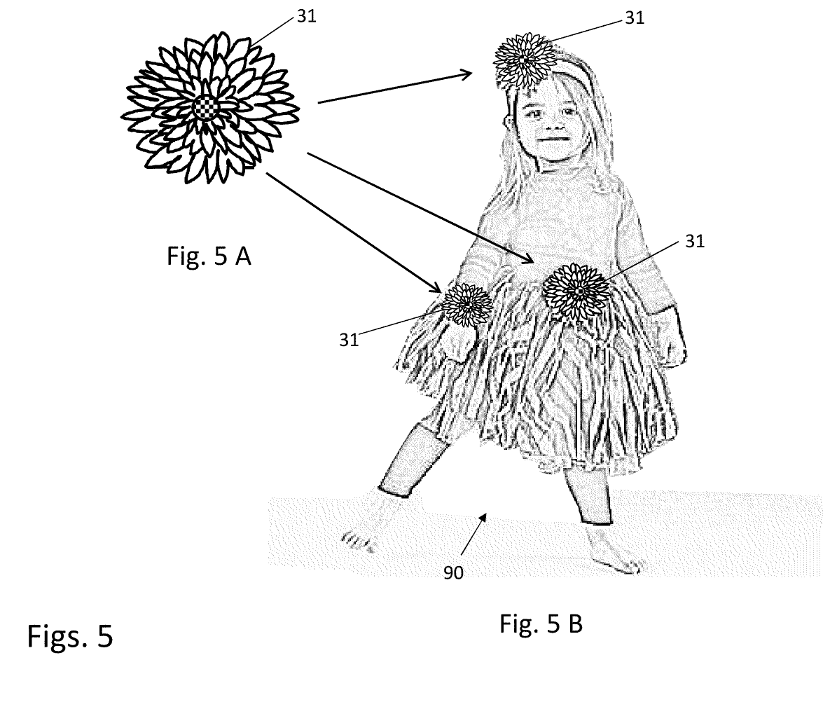

FIGS. 5 A and 5 B are sketches of a display of the accessory line in use.

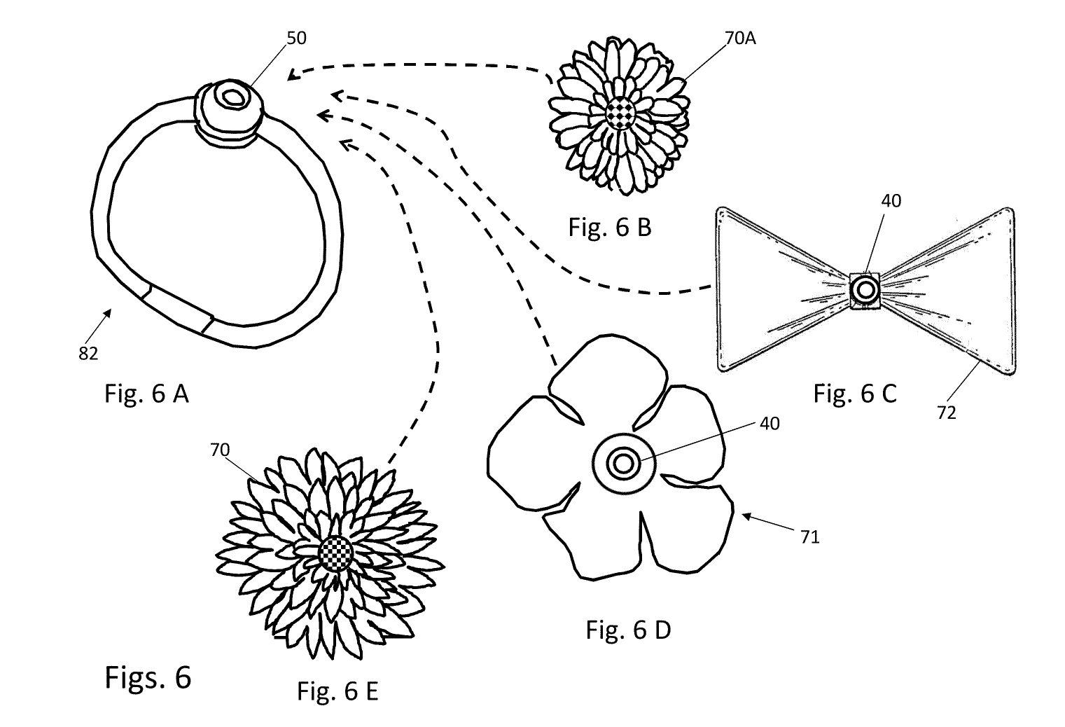

FIGS. 6 A through 6 B are sketches demonstrating the accessory line on a bracelet with various adornments/flowers/etc.

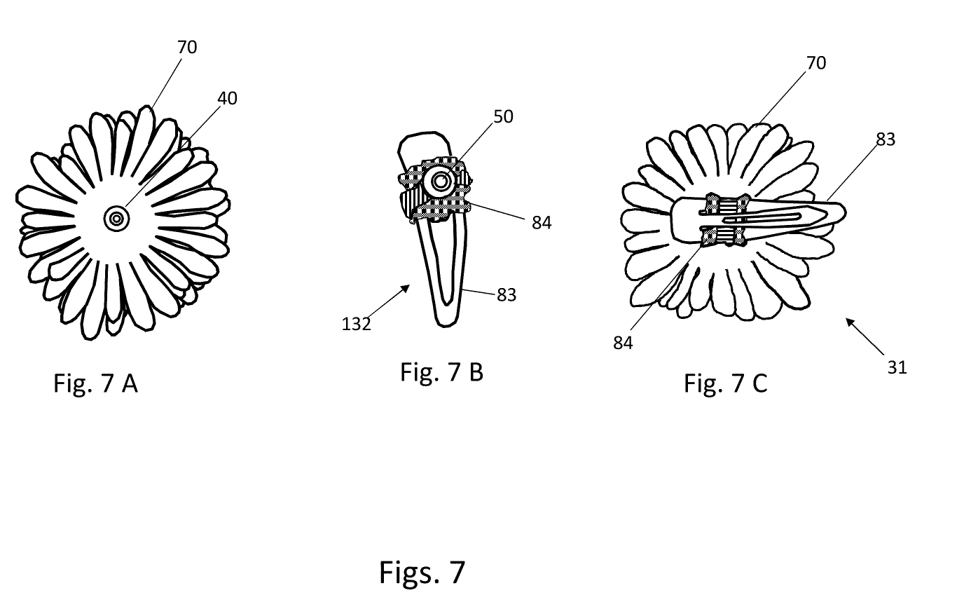

FIGS. 7 A through 7 C are sketches of the accessory line on a simple barrette for clipping to another object or into one's hair.

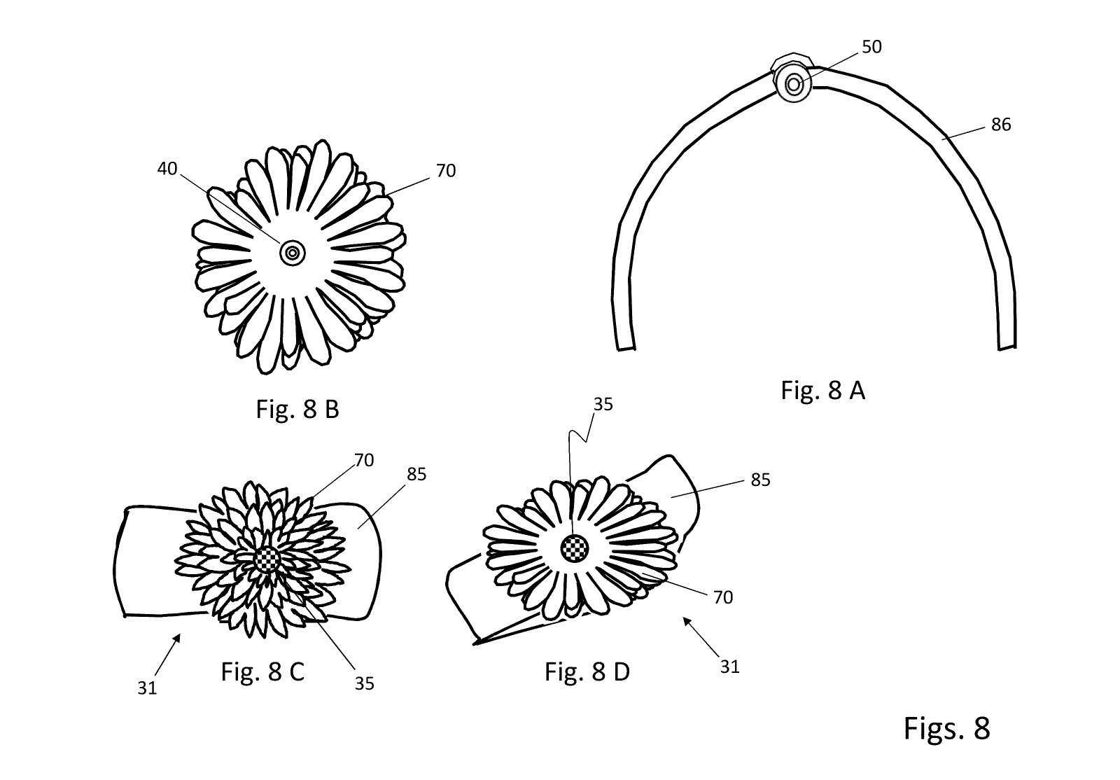

FIGS. 8 A through 8 D are sketches of the accessory line used in conjunction with firm hair bands and elastic hair bands.

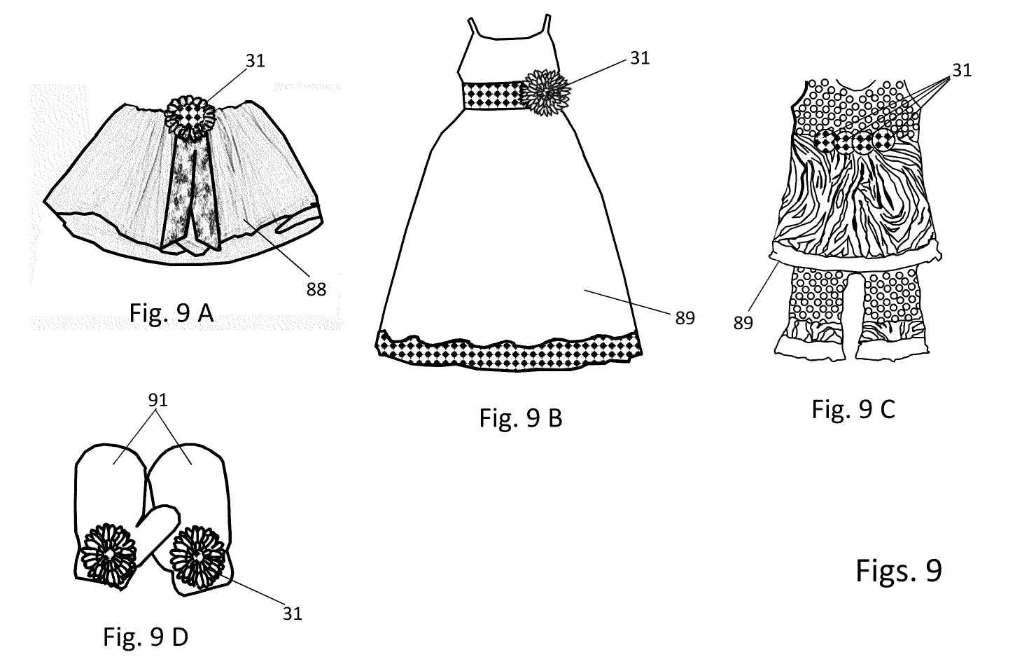

FIGS. 9 A through 9 D are sketches of the accessory line on various receiver objects.

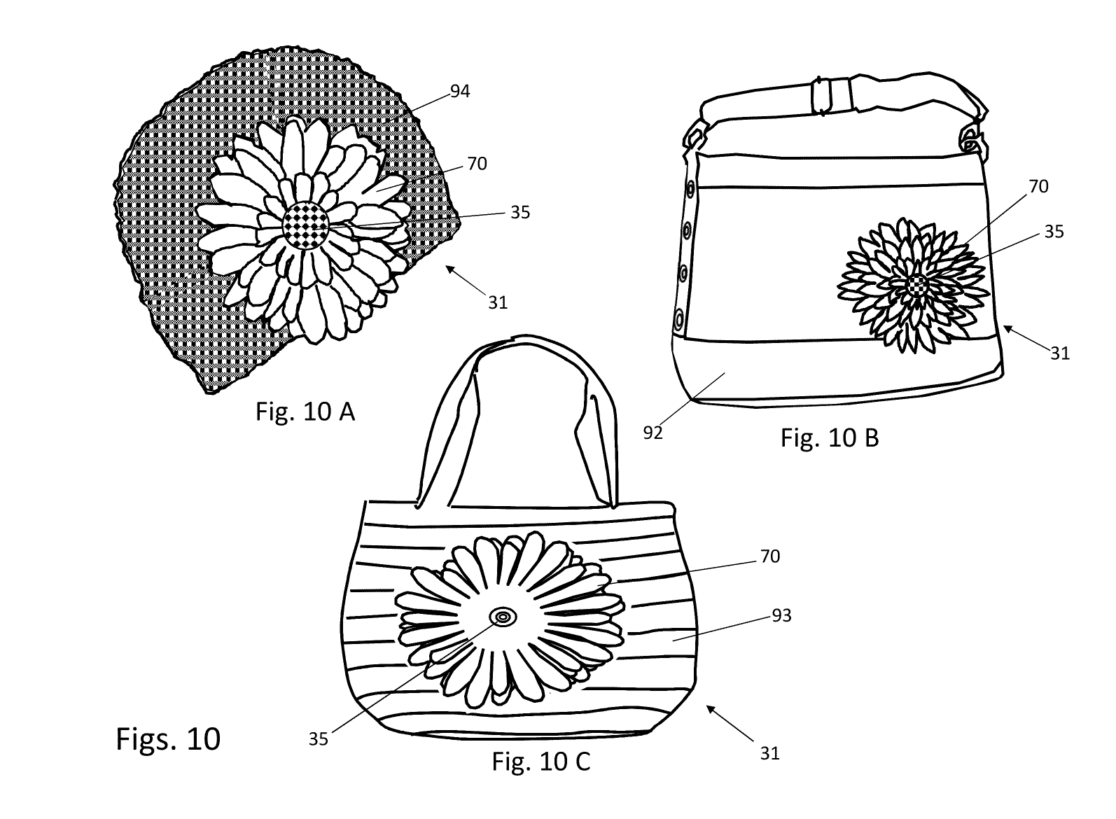

FIGS. 10 A through 10 C are more sketches of the accessory line on various other types of receiver objects.

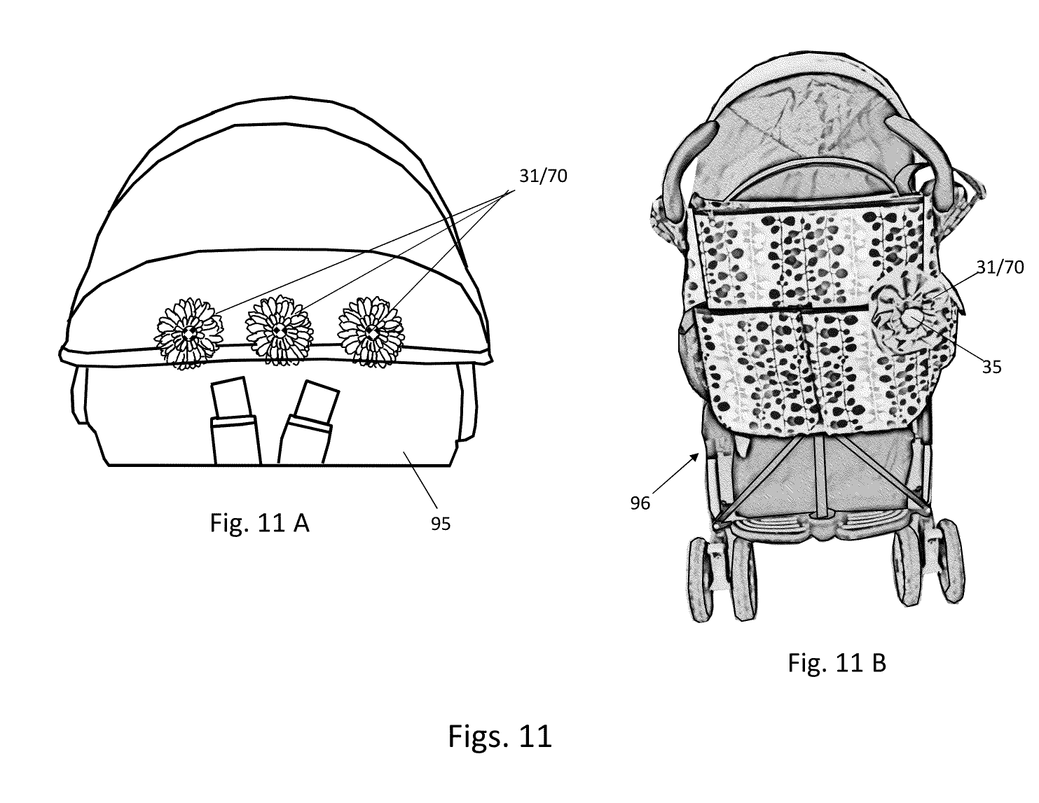

FIGS. 11 A and 11 B are sketches of the accessory line on a computer tote and a stroller.

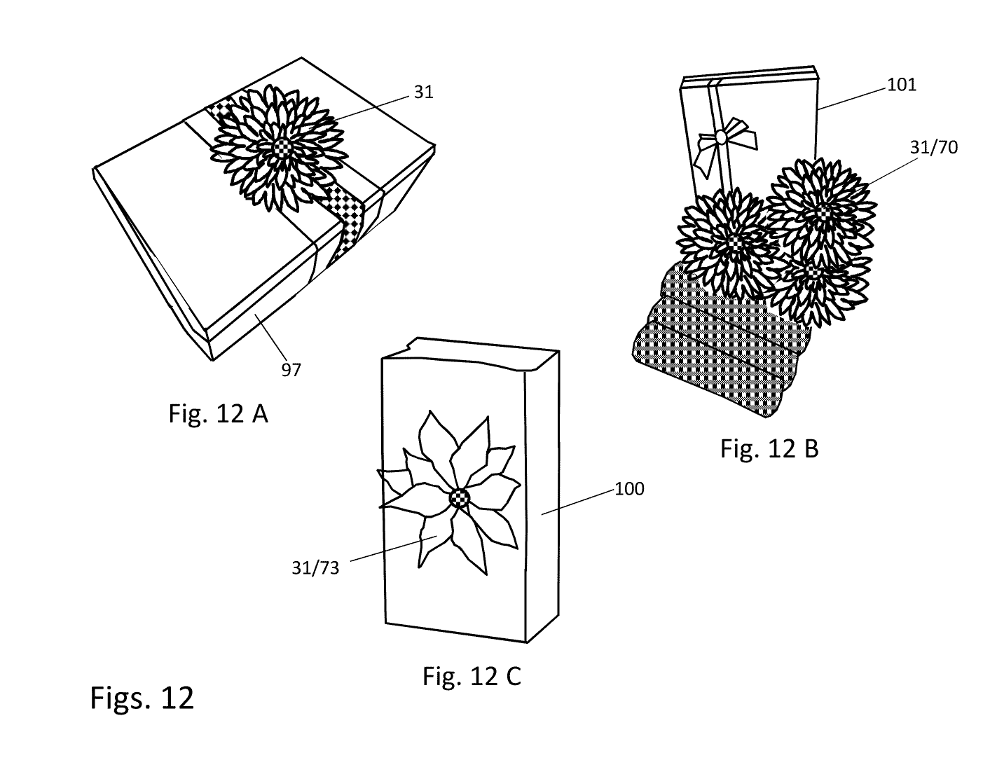

FIGS. 12 A and 12 B are sketches of the accessory line on various types of wrapping packages.

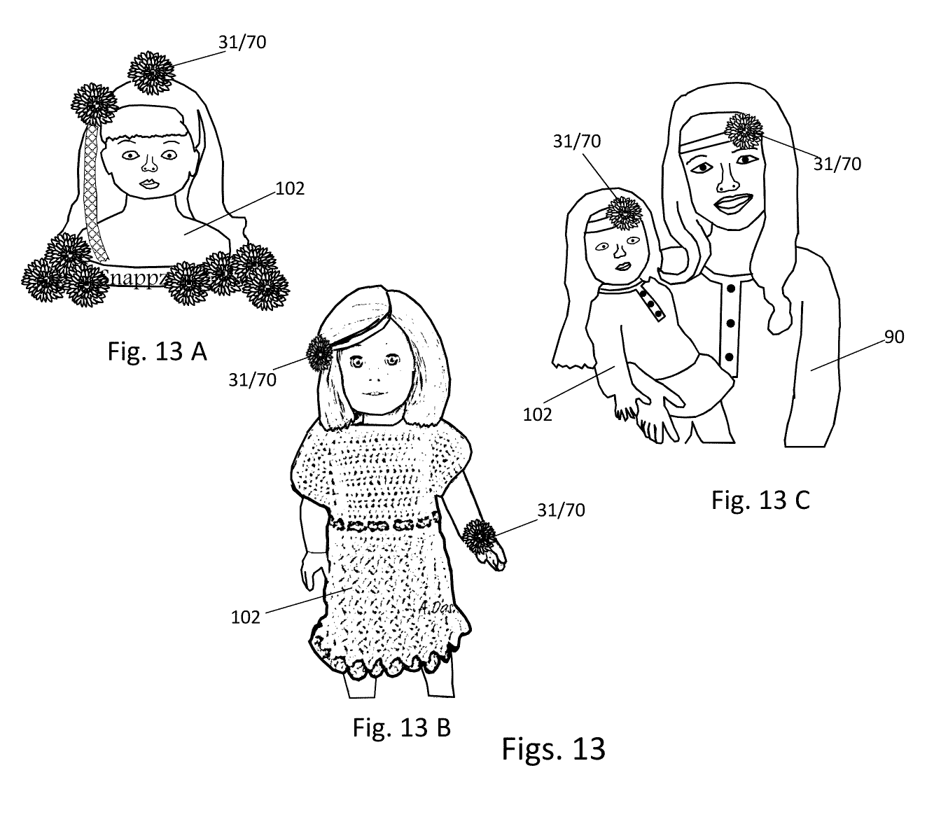

FIGS. 13 A through 13 C are sketches of the accessory line on dolls and with the owner of the doll.

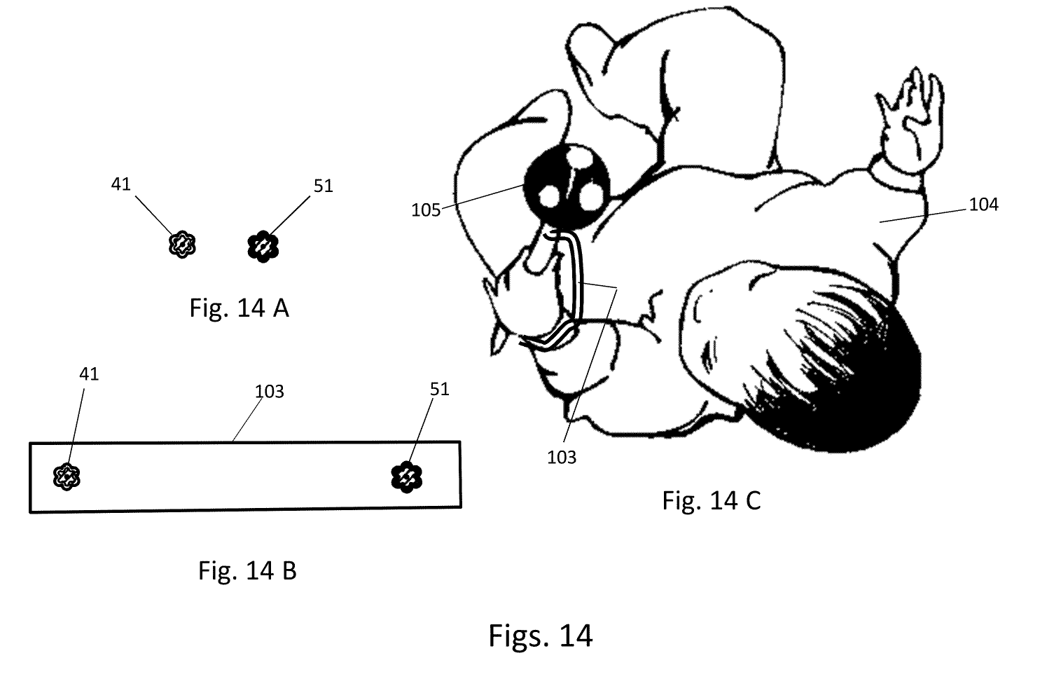

FIGS. 14 A through 14 C are sketches of a tag-along-strap with the accessory line to retain toys, rattles, pacifiers, etc.

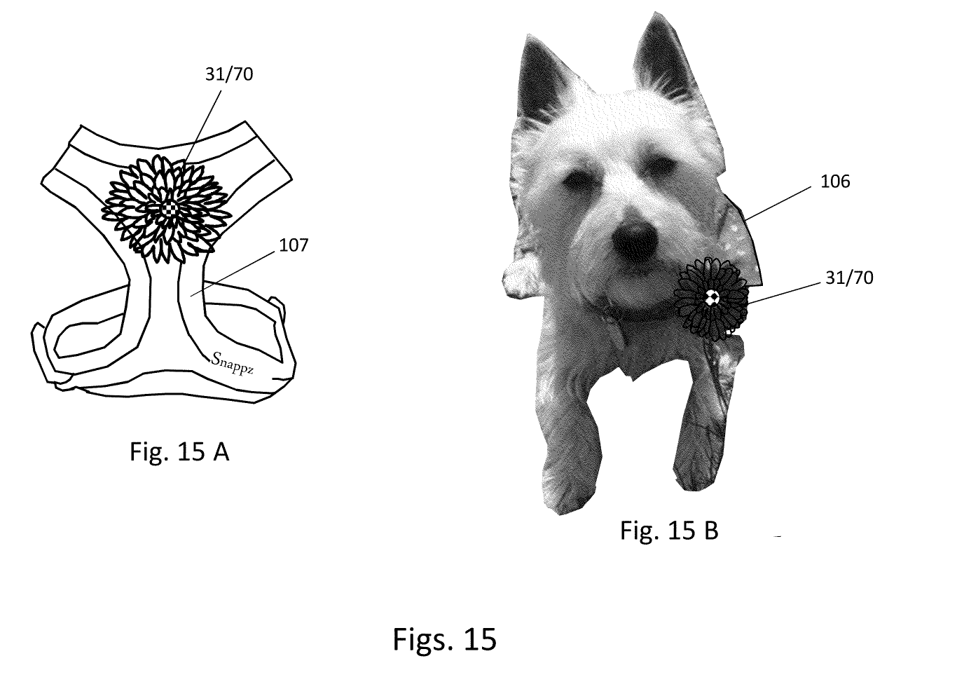

FIGS. 15 A and 15 B are sketches of the accessory line on pets.

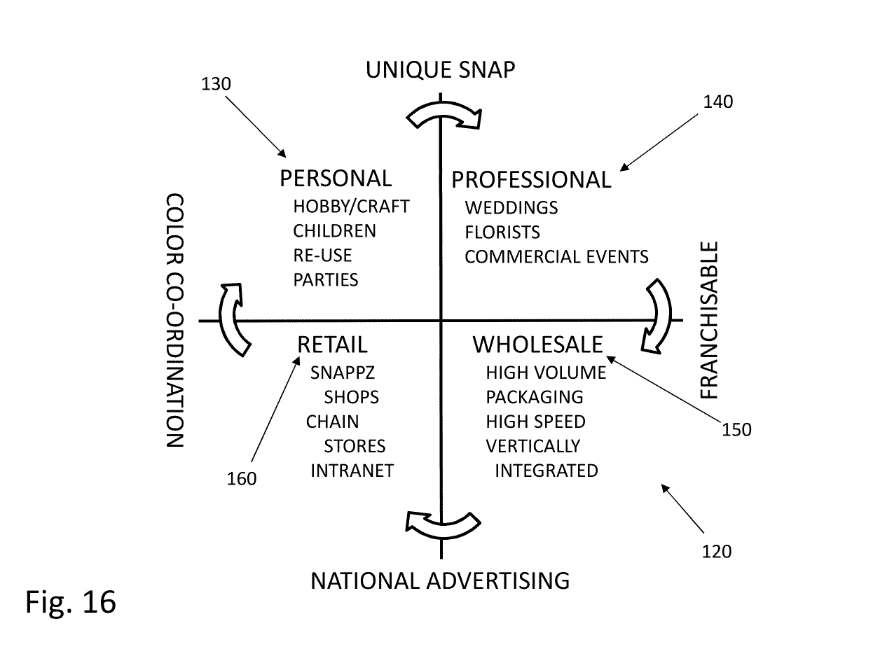

FIG. 16 is a general sketch of the business method interconnecting the accessory lines between personal, professional, wholesale and retail markets.

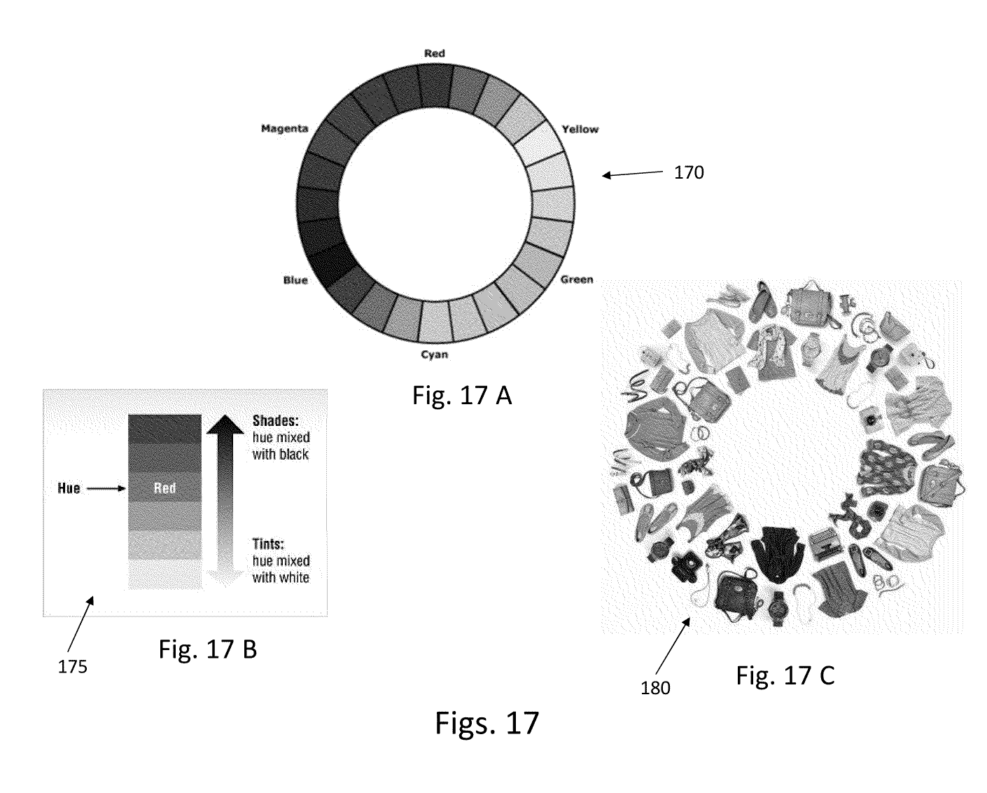

FIGS. 17 A through 17 C are sketches of color and collage wheels and hue charts for the various colors of the accessory line.

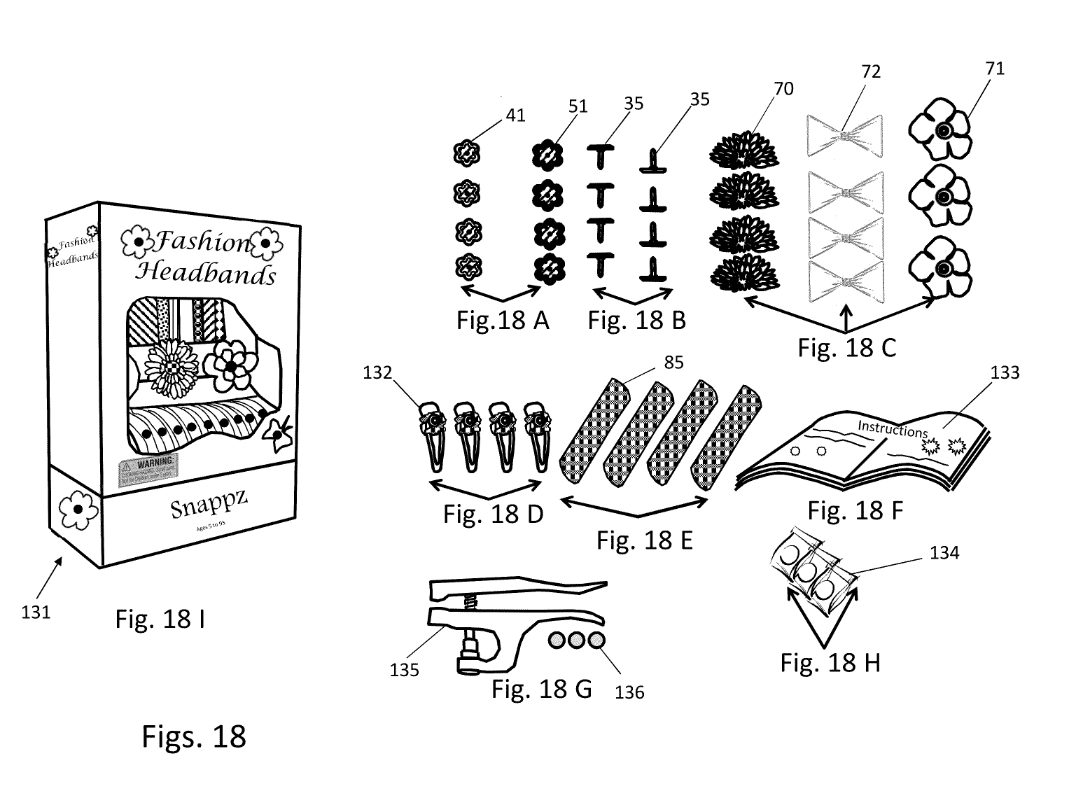

FIGS. 18 A through 18 I are sketches of the accessory line components for the Personal/Hobby portion of the Business Method for the accessory line Enterprise.

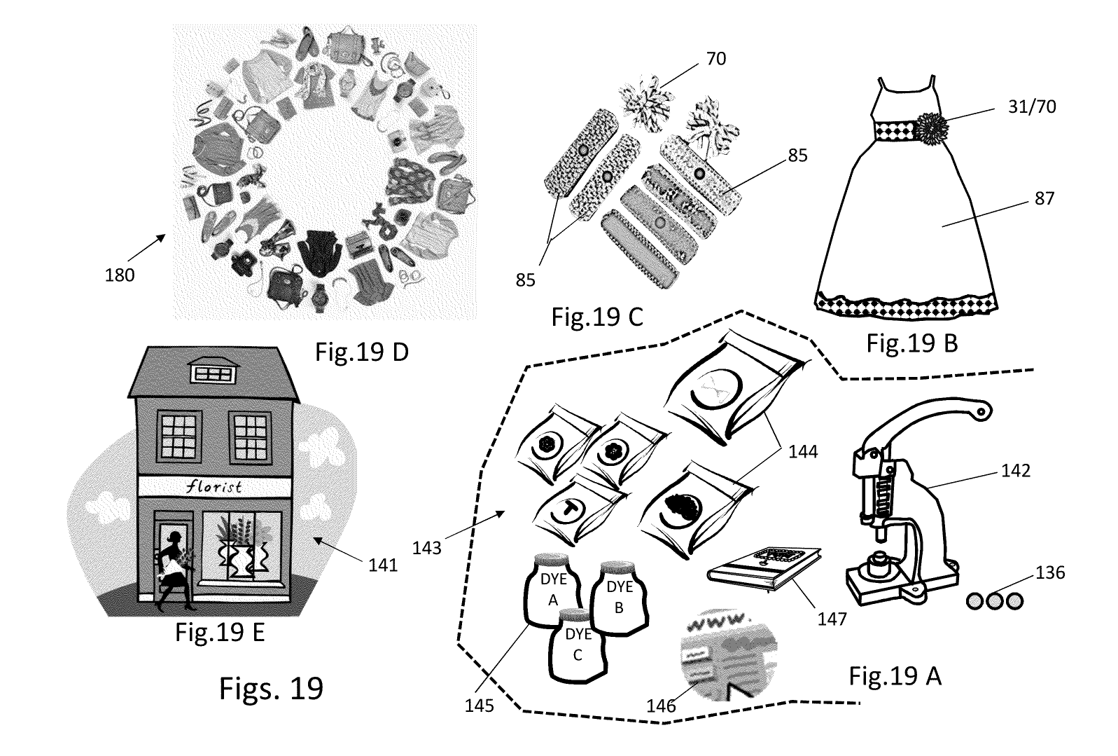

FIGS. 19 A through 19 E are sketches of the accessory line components for the Professional portion of the Business Method for the accessory line Enterprise.

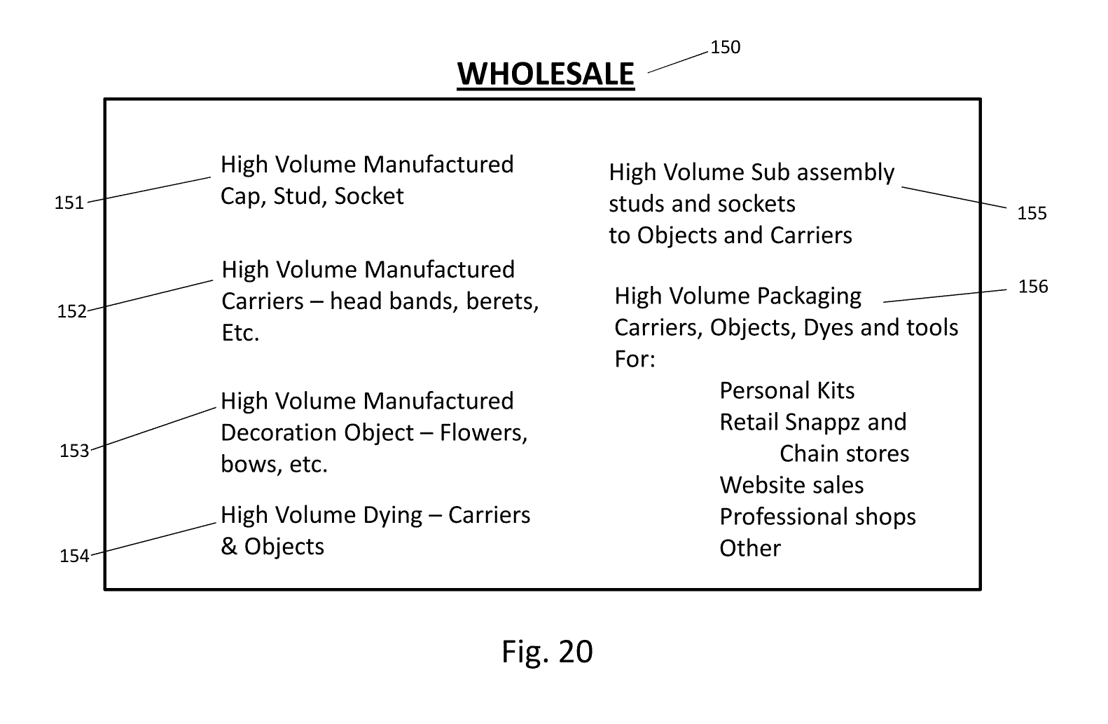

FIG. 20 is a sketch/table of the accessory line components for the Wholesale portion of the Business Method for the accessory line Enterprise.

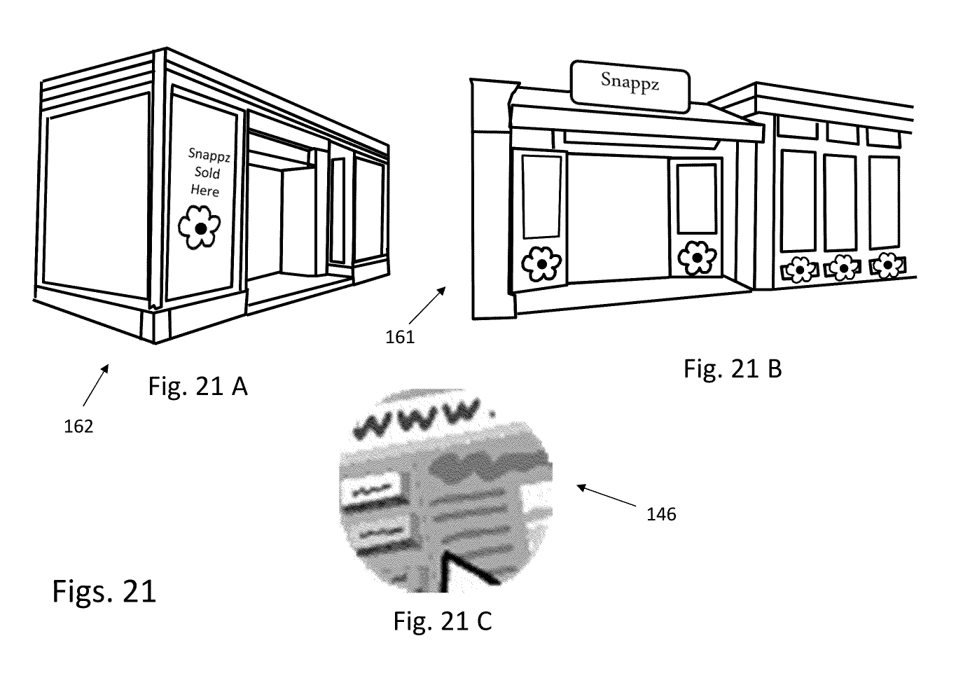

FIGS. 21 A through 21 C are sketches of the accessory line components for the Retail portion of the Business Method for the accessory line Enterprise.

### DESCRIPTION OF THE DRAWINGS

### Reference Numerals

The following list refers to the drawings:

TABLE
Reference numbers

| Ref # | Description |
|---|---|
| 31 | General Snap Device and system(assembly) |
| 34 | Assembly Steps |
| 35 | Cap |
| 36 | Cap External Flap |
| 37 | Cap Pin - post - stem |
| 38 | Cap Internal Flap |
| 39 | Means for attaching stud or socket to adornment or object |
| 40 | General Stud |
| 41 | Flower Stud - six petal |
| 42 | Cross/Plus Stud |
| 43 | Circular Round Stud |
| 44 | Oval Stud |
| 45 | Round Edge Rectangular/Square Stud |
| 46 | Dog Bone Stud |
| 47 | Simple Flower Stud |
| 50 | General Socket |
| 51 | Flower Socket - six petal |
| 52 | Cross/Plus Socket |
| 53 | Circular/Round Socket |
| 54 | Oval Socket |
| 55 | Round Edge Rectangular/Square Socket |
| 56 | Dog Bone Socket |
| 57 | Simple Flower Socket |
| 61 | Flat |
| 62 | Aperture for Cap |
| 63 | Radiused Edge |
| 69 | General adornment item |
| 69A | Alternative adornment item |
| 70 | Flower |
| 70A | Small Flower |
| 71 | Simple Petal Flower |
| 72 | Bow |
| 73 | Poinsettia Flower |
| 80 | Receiving Object |
| 80A | Alternative receiving object |
| 81 | Cloth |
| 82 | Bracelet Receiver |
| 83 | Snap Barrette |
| 84 | Elastic Wrap |
| 85 | Hair Elastic |
| 86 | Head Band |
| 87 | Formal Dress |
| 88 | Tutu |
| 89 | Jersey set |
| 90 | Young Girl |
| 90A | Person in general |
| 91 | Mitten/Gloves |
| 92 | Purse |
| 93 | Bag/Tote |
| 94 | Hat |
| 95 | Compute Tote/Bag |
| 96 | Stroller |
| 97 | Box/Carton |
| 100 | Sack |
| 101 | Wrapping Containers |
| 102 | Doll |
| 103 | Tag Along Strap |
| 104 | Baby |
| 105 | Toy/Rattle/Pacifier/etc. |
| 106 | Pet |
| 107 | Pet Harness |
| 120 | Snappz ™ Business Method |
| 130 | Personal Method |
| 131 | Hobby Pack |
| 132 | Barrette Assembly |
| 133 | Hobby Instructions |
| 134 | Dye for Objects |
| 135 | Assembly Pliers |
| 136 | Assembly Dies |
| 140 | Professional Method |
| 141 | Florist/Wedding Planner |
| 142 | Flower Press |
| 143 | Bulk Stud/Socket/Pins |
| 144 | Bulk Flowers/Bows |
| 145 | Bulk Dyes |
| 146 | Website Help Instructions |
| 147 | Professional Manual |
| 150 | Wholesale Method |
| 151 | High Volume Stud/Socket/Pin Manufacturing |
| 152 | High Volume Carrier/Manufacturing - Headbands, Barrettes, etc. |
| 153 | High Volume Manufacturing |
| 154 | High Volume Dyes |
| 155 | High Volume Sub Assembly |
| 156 | High Volume Packaging |
| 160 | Retail Method |
| 161 | Snappz ™ Stores |
| 162 | Chain Retail Store |
| 170 | Color Wheel |
| 175 | Tint/Shade Graph |
| 180 | Clothing Color Collage |
| 185 | Market distribution channels |

### DETAILED DESCRIPTION OF PREFERRED EMBODIMENT

The present development is a special interchangeable accessory line device and the business method for its implementation as an enterprise. This invention relates to a special interchangeable accessory line device and the business method for its implementation as an enterprise. The system and business method is collectively known as Snappz™. The interchangeability is a positioning fastener for fastening and joining together, in a pre-determined position, an object and an adornment such as a flower or bow. The objects may be headbands, clothing, purses, totes, pet harnesses, gloves, formal wear or the like. The assembly is provided with movable and replaceable ornamental flowers or bows, etc. of various matching or contrasting colors so as to accessorize outfits and objects in order for them to look vivid and beautiful. The present invention further relates to means for decorating objects and clothing with fashionable adornments to become accessories. Specifically, the present invention relates to interchangeable, snap-on adornments for releasable attachment to a socket member fitted to the objects and clothing. More particularly the invention relates to a connecting device consisting of two members, one (socket) of which is permanently attached an object and the other (stud) which is attached to various adornments. The members are joined together. Other interchangeable adornments may be attached to the receiving object.

The advantages for a special interchangeable accessory line device and system 31 are listed above in the introduction. Succinctly the benefits are that the Snappz™ in a word is “Marketable’. Advantages are:
1. Practical;
2. Specifications-every Snappz™ is the same size;
3. Freely replaces another;
4. User-friendly;
5. Everyday staple that still follows trends and Fads;
6. Inter-mix: Mix old with new-Snappz™ collection can be added to over the years. The new still fits the old products;
7. Socioeconomic friendly;
8. Cost Affective—i.e,—turn 1 headband into 500+looks by changing the accessory;
9. Extends useful life: Allows clothing to be worn more—i.e., Jean Jacket-change the look every day. Can be worn with jeans one day and then a dressy dress simply by changing the accessory-Parents of children will find they get more wear out of their child's wardrobe;
10. Enhances the total outfit: Enhancements that changes the appearance of an outfit in a snap-can go from day to night wear or casual to dressy;
11. Timeless—for young and old people alike, babies to the octogenarians;
12. Snappz™ takes your wardrobe from ordinary to extraordinary—boots, hats, headbands, gloves, shoes;
13. Organizer keeps Snappz™ accessories organized and easy for children to mix and match for their everyday uses;
14. Allows a child to take ownership of their appearance;
15. Allows a child to enhance their individual look-show their personality-simple to gothic; and
16. Can be purchased separately.

The preferred embodiment is a special interchangeable accessory line system 31 with a group of components, said components made of a durable material and comprised of (a) a specially configured stud 40 with positioning and other features to detachably interconnect with a socket 50 component; (b) the specially configured socket component 50 with positioning and other features to detachably interconnect with the stud 40; (c) a means 39 [such as a cap 35 with a stem 37 or pin] to removably secure the stud 40 to an adornment 69; and (d) a means 39[such as a cap 35 with a stem 37 or pin] to removably secure the socket 50 to an object 80[such as a headband 85, 86, cloth 81, purse 92, barrette 83, tote 93, pet harness 107, nametag; or the like] wherein a person 90A may detachably and position-ally connect the adornment 69 to the object 80 and later remove and replace the adornment 69 and place the said adornment 69 onto another object 80A and replace the original adornment 69 with an alternative adornment 69A for full versatility and use of the interchangeable accessory line system 31.

An alternative embodiment is a business method 120 for increasing the versatility of the above described interchangeable accessory line system 31 comprised of (a) a personal sub-method 130 with steps and features; (b) a professional sub-method 140 with steps and features; (c) an wholesale sub-method 150 with steps and features; and (d) a retail sub-method 160 with steps and features all interconnected by the interchangeable accessory line system 31 for leveraging the financial gain of interchangeability across market channels 185.

There is shown in FIGS. 1-21 a complete description and operative embodiment of the special interchangeable accessory line device and the business method for its implementation as an enterprise. In the drawings and illustrations, one notes well that the FIGS. 1 through 5 and FIGS. 5 through 16 demonstrate the general configuration and FIGS. 4 through 6, FIG. 13, and FIGS. 16 through 21 show the operation and use of this product. These various example uses are explained in the operation and use section below.

The accompanying drawings, which are incorporated in and constitute a part of this specification, illustrate an embodiment of the special interchangeable accessory line device 31 and the business method 120 for its implementation as an enterprise 31 that is preferred. The drawings together with the summary description given above and a detailed description given below serve to explain the principles of the a special interchangeable accessory line device and the business method for its implementation as an enterprise. It is understood, however, that the a special interchangeable accessory line device and the business method for its implementation as an enterprise are not limited to only the precise arrangements and instrumentalities shown. Other examples of interchangeable and positional fastening devices and business methods for marketing the same are still understood by one skilled in the art of such devices and methods and they are readily adapted to other types of systems and devices to be within the scope and spirit shown here.

FIGS. 1 A through 1 D are examples of the snap device 31 for interchangeability with the accessory line, a brief overview of assembling 34 the snaps 31, a display of the line in use and the business method 120 of leveraging the line financially with interconnected marketability.

FIGS. 2 A through 2 E are sketches of the general round snap 31 consisting of a socket 53, stud 43 and cap 35, the sketches shown from various views. One first should understand the general configurations may be from a plethora of geometric shapes (see FIG. 3). Here, the general round shape shows the features. For the stud 43 and the socket 53, each has a center aperture 62 for the cap 35 to intersect with its stem 37. The aperture 62 is essentially centered on the flat surface 61 of the stud 43 and socket 53. All of the edges of the stud 43 and socket 53 that press fit together anticipate radiused edges 63. This is a well-known feature for mating parts such as the socket 53 and stud 43. These mating parts (43, 53) are designed as to have a hard press fit so as the radiused edge of the stud 43 is slightly larger than the radiused edge 63 of the socket 53. Hence the two components (stud 43 and socket 53) snap together, yet may be detached from each other and re-used. First, the assembly 31 has the stud 43, the adornment 69 then the cap 35 with its stem 37 piercing the adornment 69 and inserted through the aperture 62 of the stud 43. The stem 37 is then smashed or flattened and dis-formed to cause an enlarged stem portion that holds the adornment 69 “sandwiched between” the back flat of the stud 43 and the inner flat 38 of the cap 35. Further, the assembly 31 has the socket 53, the object 85 then the cap 35 with its stem 37 piercing the object 85 and inserted through the aperture 62 of the socket 53. The stem 37 is then smashed, smushed, compressed and distorted, or flattened and dis-formed to cause an enlarged stem portion that holds the adornment 69 “sandwiched between” the back flat of the socket 53 and the inner flat 38 of the cap 35. The durable materials for the components (stud, socket, and cap) of the assembly 31 may be from a plethora of materials. The obvious composite materials including various plastics or pressed materials is preferred. Likewise the components may be fabricated of metals such as various steels and tin materials. For some specialty items, formed, compressed composite paper goods/cardboard may have recyclable uses.

FIGS. 3 A through 3 F1 are some examples of the various types of snap components anticipated with this accessory line—all are shown from generally a top view. A general “dog-bone” stud 46 and socket 56 are shown in FIGS. 3 A and 3 A1. A general “cross or plus” stud 42 and socket 52 are shown in FIGS. 3 B and 3 B1. A general “rounded edge rectangular or square” stud 45 and socket 55 are shown in FIGS. 3 C and 3 C1. A general “simple flower” stud 47 and socket 57 are shown in FIGS. 3 D and 3 D1. A general “oval or ellipse” stud 44 and socket 54 are shown in FIGS. 3 E and 3 E1. A general “six petal flower” stud 41 and socket 51 are shown in FIGS. 3 F and 3 F1. All of these configurations except for the circular snap have the ability to turn the adornment in relation to the object and position the adornment to be affixed on a desired position.

FIGS. 4 A and 4 B are sketches of the general assembly of the snap consisting of the cap, stud and sockets attached to the receiving object and the flower or other adornment. The components are shown from generally a side view. This method of assembly is explained below in the operations section.

FIGS. 5 A and 5 B are sketches of a display of the accessory device and system 31 in use. Here a flower shaped assembly 31 is shown for the wrist/bracelet 82 or a belt/waist or a hair band/barrette 83, 85 for a young girl 90.

FIGS. 6 A through 6 B are sketches demonstrating the accessory system 31 on a bracelet 82 with various adornments/flowers/etc. The small flower 70A in FIG. 6 B, the bow 72 in FIG. 6 C, the simple petal flower 71 in FIG. 6 D and the flower (chrysanthemum-like) 70 in FIG. 6 E all may be interchanged with the bracelet 82 in FIG. 6 A as the adornments 69 are placed detachably onto the socket 50.

FIGS. 7 A through 7 C are sketches of the accessory system and device 31 on a simple barrette 83 for clipping to another object or into one's hair. Here the receiving socket 50 is attached to an elastic wrap 84 that is then attached to the barrette 83. This barrette 83 then may have an adornment 69 such as the flower 70 shown here detachably snapped onto the barrette 83 and placed into one's hair or affix to another object.

FIGS. 8 A through 8 D are sketches of the accessory system and device 31 used in conjunction with firm hair bands 86 and elastic hair bands 85. As shown in the figures and drawings, the flower devices 70 are snapped on to receivers 50 on the bands 86, 85. One notes the stud 40 in FIG. 8 B in the center of the flower 70 and the caps 35 in FIGS. 8 C and 8 D.

FIGS. 9 A through 9 D are sketches of the accessory system and device 31 on various receiver objects. Receiver objects in the sketches include a tutu 58, a formal dress or garment 87, a jersey set 89, and a pair of mittens/gloves 91. Each receiver has one or more of the special interchangeable accessory line device 31 removably attached.

FIGS. 10 A through 10 C are more sketches of the accessory device 31 on various other types of receiver objects. The objects shown in this view include a hat 94, a purse 92 and a tote 93. Again one sees the removably attached devices 31.

FIGS. 11 A and 11 B are sketches of the accessory devices 31 on a computer tote 95 and a stroller 96.

FIGS. 12 A and 12 B are sketches of the accessory device 31 on various types of boxes 97, on wrapping containers 101 and on sacks or even gift bags 100.

FIGS. 13 A through 13 C are sketches of the accessory devices on dolls 102 and with the owner 90 of the doll 102. Mix and match accessories of the owner and doll are very effective means to keep costs low, yet have a variety of adornments 69.

FIGS. 14 A through 14 C are sketches of a tag-along-strap 103 with the accessory system 31 to retain toys, rattles, pacifiers, etc. The combination here is comprised of the preferred six petal stud 41 and socket 51. The strap 103 is detachably secured to the toy or pacifier 105 and the baby 104. One notes that the receiver snap may also be attached directly to the baby clothes, stroller of other items.

FIGS. 15 A and 15 B are sketches of the accessory devices 31 to accessorize on pets 106 or a pet harness 107.

FIG. 16 through FIG. 21 are discussed in the operations section, below.

The details mentioned here are exemplary and not limiting. Other specific components and manners specific to describing a special interchangeable accessory line device and the business method for its implementation as an enterprise may be added as a person having ordinary skill in the field of adornment fastener systems and devices well appreciates.

### OPERATION OF THE PREFERRED EMBODIMENT

The preferred embodiment is a special interchangeable accessory line device and system 31 with a group of components, said components made of a durable material and comprised of (a) a specially configured stud with positioning and other features to detachably interconnect with a socket component; (b) the specially configured socket component with positioning and other features to detachably interconnect with the stud; (c) a means [such as a cap with a stem or pin] to removably secure the stud to an adornment; and (d) a means [such as a cap with a stem or pin] to removably secure the socket to an object [such as a headband, cloth, purse, barrette, tote, pet harness, nametag; or the like] wherein a person may detachably and position-ally connect the adornment to the object and later remove and replace the adornment and place the said adornment onto another object and replace the original adornment with an alternative adornment for full versatility and use of the interchangeable accessory line system.

An alternative embodiment is a business method for increasing the versatility of the above described interchangeable accessory line system comprised of (a) a personal sub-method with steps and features; (b) a professional sub-method with steps and features; (c) an wholesale sub-method with steps and features; and (d) a retail sub-method with steps and features all interconnected by the interchangeable accessory line system for leveraging the financial gain of interchangeability across market distribution channels.

FIGS. 4 A and 4 B are sketches of the general assembly of the snap consisting of the cap 35, stud 40 and socket 50 attached to the receiving object 80 and the flower 70 or other adornment. The components are shown from generally a side view. Here, the general shape shows the features. Generally speaking, the stud 40 and the socket 50, each has a center aperture 62 for the cap 35 to intersect with its stem 37. The aperture 62 is essentially centered on the flat surface 61 of the stud 40 and socket 50. All of the edges of the stud 40 and socket 50 that press fit together anticipate radiused edges 63. This is a well-known feature for mating parts such as the socket 53 and stud 43. These mating parts (40, 50) are designed as to have a hard press fit so as the radiused edge of the stud 40 is slightly larger than socket opening with the radiused edge 63 of the socket 50. Hence the two components (stud 40 and socket 50) snap together, yet may be detached from each other and re-used. First, the assembly 31 has the stud 40, the adornment 69 then the cap 35 with its stem 37 piercing the adornment 69 and inserted through the aperture 62 of the stud 40. Next, the stem 37 is then smashed or flattened and dis-formed to cause an enlarged stem portion that holds the adornment 69 “sandwiched between” the back flat of the stud 40 and the inner flat 38 of the cap 35. Second and similarly, the assembly 31 has the socket 50, the object 85 then the cap 35 with its stem 37 piercing the object 85 and inserted through the aperture 62 of the socket 50. The stem 37 is then smashed or flattened and dis-formed to cause an enlarged stem portion that holds the adornment 69 “sandwiched between” the back flat of the socket 50 and the inner flat 38 of the cap 35. Once the two sub-assemblies are assembled and the stems smashed, each sub assembly is ready to detachably “snap together”. Here the two halves are placed tightly and the overall device 31 is completed and helped by the stud 40 and socket 50 being detachably secured with a press fit and the mechanical interference of the radiused edges 63 of the stud 40 and socket 50.

FIGS. 5 A and 5 B are sketches of a display of the accessory line in use. FIGS. 5 A and 5 B are sketches of a display of the accessory device and system 31 in use. Here a flower shaped assembly 31 is shown for the wrist/bracelet 82 or a belt/waist or a hair band/barrette 83, 85 for a young girl 90. One can note that the adornments 69 may be interchanged with various positions at the waist, wrist or hair position . . . or all three.

FIGS. 6 A through 6 B are sketches demonstrating the accessory line on a bracelet with various adornments 69/flowers 70, 70A, 71, 72/etc. The accessory system 31 on a bracelet 82 with various adornments/flowers/etc. The small flower 70A in FIG. 6 B, the bow 72 in FIG. 6 C, the simple petal flower 71 in FIG. 6 D and the flower (chrysanthemum-like) 70 in FIG. 6 E all may be interchanged with the bracelet 82 in FIG. 6 A as the adornments 69 are placed detachably onto the socket 50.

FIGS. 13 A through 13 C are sketches of the accessory devices on dolls 102 and with the owner 90 of the doll 102. Mix and match accessories of the owner and doll are very effective means to keep costs low, yet have a variety of adornments 69. Operational, virtually any adornment 69 may be mated to the doll 102 or young person 90 using the device 31.

FIG. 16 is a general sketch of the business method 120 interconnecting the accessory system 31 between personal sub-method 130, professional sub-method 140, wholesale sub-method 150 and retail sub-method 160 market penetrations. The unique snap system 31 permits the various markets to accessorize and make or sell product that interchanges with the other markets. This collective business method permits the accessory devices to have color coordination, national advertising and even franchising. By synergistically connecting the product, all the four sub-methods of market penetration benefit. This means each method may exist alone or coexist and benefit from less complexity of advertising, grow from a personal/hobby 120 introduction into retail 140, and benefit from large scale manufacturing and whole sale 150 distribution. Plus, the connection to the professional submarket 140 permits florists and wedding planners to also benefit from a well-entrenched accessorizing system 31.

FIGS. 17 A through 17 C are sketches of color wheels 170, collage matching wheel charts 180 and hue charts 175 for the various colors of the accessory line. These are used normally by professionals and wholesale activities to provide coordinating colors in various tints and shades.

FIGS. 18 A through 18 I are sketches of the accessory line components for the Personal/Hobby sub-method 120 portion of the Business Method 120 for the accessory system 31 enterprise. The personal sub-method permits introduction as a hobby, as a craft, to children 90 and at parties to originally introduce the use of the special interchangeable accessory device 31 and the initial parts of the larger business method 120 for its implementation as an enterprise. Clothing is viewed by most families as an investment. Customers want nice things but they can't always afford to spend a lot. Since society has turned somewhat into a “disposable society” many people have become accustomed to clothing being cheap and something that is discarded and thrown away after a few uses, often before it wears out. (Snappz™ permits one to takes their wardrobe from Ordinary to Extraordinary and it makes it last much longer. It allows a person to get more wear out of the clothing in which they have invested. The versatile and changeable accessories allow for the wardrobe to be varied, upgraded and coordinated with needs and occasions without starting the outfits from scratch. People may buy QUALITY pieces that will last decades and can be upgraded and varied inexpensively and easily. With Snappz™ a person may create numerous looks by enhancing outfits by the interchangeability that Snappz™ provides. Staring with a personal or simple hobby method 130 the Snappz™ provides an interchangeable ensemble. Snappz™ can provide enhancement of anyone's wardrobe regardless of age, culture, socioeconomic status or ones size. (Each Snappz™ piece enhances another item be it clothing, headbands, gloves, socks, shoes, etc.). For example, a light blue headband can change its appearance in an instant by snapping on a new accessory. The permutations and possibilities are virtually and essentially endless. A wardrobe should be built on classic interchangeable pieces that go with at least 60% of the wardrobe's counterparts. With the higher percentage of compatibility the ultimate use and life of the clothes and other wardrobe items such as purses, shoes, bags, are always better. To start the hobby outlets, hobby packs 131 may be provided with the preferred 6 petal flower studs 41, sockets 51, caps 35. Included would also be a variety of adornments 69 like flowers 70, bows 72, and simple petal flowers 71. Some objects 80 would be also in the pack 131 such as barrette assemblies 132 and head bands 85. For some advanced kits, there may be dyes 134 for changing colors of the devices 31. Instructions 133 as well as how to get to the instruction websites 146 could be in the kits 131. Finally, a set of simple smash pliers 135 and crimp dies 136 would be available for some kits. All of this is anticipated in the first stage sub-method at a personal or hobby 130 introduction level.

FIGS. 19 A through 19 E are sketches of the accessory line components for the Professional sub-method 140 portion of the Business Method 120 for the accessory system 31 enterprise. At this stage the system 31 would be introduced to the professional wedding planners, florists, commercial event personnel, and the like. Lager quantity production of adornments and objects is expected. The ability to have bulk dyes 145 for the adornments 69 would also require a more in-depth instruction guide 147 and a website 146 presence. The preferred six (6) petal flower studs 41, sockets 51, caps 35 would be provided in bulk means 143. Likewise the variety of adornments 69 like flowers 70, bows 72, and simple petal flowers 71 would be in bulk supply 144. A larger, more formidable stem smash press 142 and die sets 136 is anticipated as part of the professional sub-method 140. This would be used by florists 141 and planners for doing multiple formal wear dresses 87 and other formal attire plus flowers, center pieces, decorations, and the like. Hair adornments and head bands 85 could be colored based on a color collage 180 to match the wedding needs in this professional sub-method 140 preparations.

FIG. 20 is a sketch/table of the accessory system components for the Wholesale sub-method 150 portion of the Business Method 120 for the accessory line Enterprise. This method would contemplate high production of the special interchangeable accessory system and devices 31.

| Item | Description |
|---|---|
| 1 | High Volume Manufacturing - Cap, Stud, Socket - 151 |
| 2 | High Volume Manufacturing Carriers - head bands, |
| | barrettes, Etc. - 152 |
| 3 | High Volume Manufacturing Decoration Object - |
| | Flowers, bows, etc. - 153 |
| 4 | High Volume Dying - Carriers & Objects - 154 |
| 5 | High Volume Sub assembly studs and sockets to Objects |
| | and Carriers - 155 |
| 6 | High Volume Packaging Carriers, Objects, Dyes and |
| | tools - 156 For: |
| | Personal Kits, |
| | Retail Snappz and Chain stores |
| | Website sales |
| | Professional shops |
| | Other |

FIGS. 21 A through 21 C are sketches of the accessory system 31 components for the Retail sub-method 160 portion of the Business Method 120 for the accessory line Enterprise. This retail focus would be with franchised Snappz™ shoppes 161, with chain stores 162 that sell Snappz™ special interchangeable accessory systems and devices, and website 146 E-Commerce retail.

Many uses are anticipated for the special interchangeable accessory line device 39. Some examples of use in different market channels 185, and not shown as limitations, are provided in the following Tables.

| | | B | |
|---|---|---|---|
| | A | Toddlers- | C |
| TBL | Babies | Children | Teens |
| 1 | Headbands | Headbands | Headbands |
| 2 | Clips | Clips | Clips |
| 3 | Ponytails | Ponytails | Ponytails |
| 4 | hats | hats | hats |
| 5 | gloves | gloves | gloves |
| 6 | socks/booties | shoes | shoes |
| 7 | shoes | slippers | slippers |
| 8 | slippers | swimsuits | swimsuits |
| 9 | bibs | sweaters | sweaters |
| 10 | swimsuits | dresses | dresses |
| 11 | sweaters | bandanas | bandanas |
| 12 | dresses | jackets | jackets |
| 13 | strollers | skirts | skirts |
| 14 | bandanas | shirts | shirts |
| 15 | overalls | shorts | shorts |
| 16 | tutus | pants/jeans | pants/jeans |
| 17 | jackets | belts | belts |
| 18 | One-sies | ear warmers | ear warmers |
| 19 | Jersey sets | bobby pins | bobby pins |
| 20 | skirts | | |
| 21 | shirts | | |
| 22 | shorts | | |
| 23 | pants/jeans | | |
| 24 | jumpers | | |
| 25 | pacifier clips | | |
| 26 | belts | | |
| 27 | ear warmers | | |
| 28 | bobby pins | | |
| 29 | diaper bag | | |

| | | | | G |
|---|---|---|---|---|
| | D | E | F | Business- |
| | Women | Pets/animals | Bags and Novelty | Promotional |
| 1 | Headbands | beds | beach towels | name badges |
| 2 | Clips | collars | diaper bags | scrubs |
| 3 | Ponytails | leashes | travel bags | totes for |
| | | | | conventions/ |
| | | | | company |
| | | | | gatherings |
| 4 | hats | outfits | cosmetic bags | desk |
| | | | | displays |
| 5 | gloves | hair | backpacks | Card holders |
| | | accessories | | |
| 6 | shoes | sweaters | satchels | laptop/pads |
| 7 | slippers | bandanas | hobo bags | cellphone |
| | | | | holder |
| 8 | swimsuits | harnesses | overnight bags | Computer |
| | | | | bags |
| 9 | sweaters | | canvas bags | |
| 10 | dresses | | tote bags | |
| 11 | bandanas | | beach bags | |
| 12 | jackets | | purses | |
| 13 | skirts | | strollers | |
| 14 | shirts | | roll-up diaper | |
| | | | changing pads | |
| 15 | shorts | | roll-up blankets | |
| 16 | pants/jeans | | messenger bags | |
| 17 | belts | | picnic blankets | |
| 18 | ear warmers | | wallets | |
| 19 | bobby pins | | Laptop/tablet | |
| | | | computer bags | |
| 20 | | | journals | |
| 21 | | | gift bags | |

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

With this description it is to be understood that the a special interchangeable accessory line device and the business method for its implementation as an enterprise is not to be limited to only the disclosed embodiment of product. The features of the interchangeable fastener system and the business method described above are intended to cover various modifications and equivalent arrangements included within the spirit and scope of the detailed description and operation of the system presented in the above paragraphs and the accompanying drawings.

What is claimed is:

1. A special interchangeable accessory line system with a group of components, said components made of a durable material and comprised of
(a) a specially configured stud with positioning and other features to detachably interconnect with a socket component;
(b) the specially configured socket component with positioning and other features to detachably interconnect with the stud;
(c) a means to removably secure the stud to an adornment; and
(d) a means to removably secure the socket to an object
wherein a person may detachably and position-ally connect the adornment to the object and later remove and replace the adornment and place the said adornment onto another object and replace the original adornment with an alternative adornment for full versatility and use of the interchangeable accessory line system.

2. The device according to claim 1 wherein the means to removably secure the stud is a cap and pin combination that is smashed flat after assembly to the stud.

3. The device according to claim 1 wherein the means to removably secure the socket is a cap and pin combination that is smashed flat after assembly to the socket.

4. The device according to claim 1 wherein the structural cross section of the socket and studs is selected from the group consisting of an essentially circular, dog-bone, cross, plus, rounded edge rectangular, square, simple flower, ovular, elliptical, and six petal flower shape.

5. The device according to claim 1 wherein the durable materials is metal.

6. The device according to claim 5 wherein the metal is steel alloy.

7. The device according to claim 5 wherein the metal is tin.

8. The device according to claim 1 wherein the durable material is a composite material.

9. The device according to claim 8 wherein the composite material is a plastic.

10. A special interchangeable accessory line system with a group of components, said components made of a durable plastic material and comprised of
(a) a specially six petal flower configured stud with positioning and other features to detachably interconnect with a socket component;
(b) the socket as a specially six petal flower configured socket component with positioning and other features to detachably interconnect with the stud;
(c) a cap with a stem to removably secure the stud to an adornment; and
(d) a cap with a stem to removably secure the socket to an object wherein a person may detachably and position-ally connect the adornment to the object and later remove and replace the adornment and place the said adornment onto another object and replace the original adornment with an alternative adornment for full versatility and use of the interchangeable accessory line system.

11. The device according to claim 10 wherein the object is selected from the group consisting of a headband, cloth, purse, barrette, tote, pet harness, and nametag.

12. A business method for increasing the versatility of an interchangeable accessory line system, the method comprised of
(a) a personal sub-method with steps and features;
(b) a professional sub-method with steps and features;
(c) an wholesale sub-method with steps and features; and
(d) a retail sub-method with steps and features
wherein all the sub-methods are interconnected by the interchangeable accessory line system for leveraging the financial gain of interchangeability across market channels.
